(19) United States
(12) Patent Application Publication
(10) Pub. No.: US 2004/0060074 A1
(43) Pub. Date: Mar. 25, 2004

(54) Video distribution system with increased centralized processing

(76) Inventors: Ganesh Basawapatna, Greenwood Village, CO (US); Varalakshani Basawapatna, Greenwood Village, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/666,646

(22) Filed: Sep. 17, 2003

Related U.S. Application Data
(60) Provisional application No. 60/411,960, filed on Sep. 19, 2002.

(51) Int. Cl. H04N 7/173; H04N 7/16; H04N 7/12; H04N 11/02; H04N 11/04; H04N 5/50

(52) U.S. Cl. 725/131; 725/120; 725/151; 348/731; 348/388.1

(57) ABSTRACT

A cable distribution system with distributed architecture in a multi-dwelling unit or building(s). Each dwelling has at least one Room Interface Unit (RIU), one for each television. There is a local service module associated with a group of dwellings/RIUs (e.g., one per floor). There is also a local headend in the vicinity or in the building or set of buildings. The local headend has a block of integrated receiver/decoders which can be controlled to tune in a selected video channel. The selected video channels and a group of standard channels are multiplexed and sent to the local service modules where a group of programmable converters (one for each RIU) place the channel selected by its corresponding RIU at a predetermined frequency. All of the RIUs associated with a particular local service module can receive a single multiplexed signal and each RIU uses bandpass filtering to select its selected channel. Forward and return DOCSIS channels are also provided.

### CROSS-REFERENCE TO RELATED APPLICATIONS

This application claims priority from U.S. Provisional Patent Application No. 60/411,960 filed Sep. 19, 2002, entitled “Video Distribution System with Increased Centralized Processing”, the contents of which are incorporated herein by reference.

### FIELD OF THE INVENTION

This present invention relates generally to video distribution systems, and more particularly to those intended for hotels and multiple dwelling units (MDUs) and having increased circuit complexity upstream and decreased circuit complexity downstream.

### BACKGROUND OF THE INVENTION

Cable and satellite based video distribution systems typically include a set-top box (STB). Typically, these STBs include circuitry to convert the analog and/or digital signals received from the cable or satellite system into a signal suitable for analog television sets. In addition, there is typically circuitry to allow the customer to select the desired channel and thus control which received video channel is converted to the frequency for the television. STBs have also come to include circuitry that is addressable from upstream in the video distribution system so that the STB can be commanded to enable or disable the selection of certain individual channels, such as may be desired for pay channels such as HBO, and so forth. More recent systems with digital set top boxes allow one or more functions such as Interactive Program Guide, Video On Demand, Interactive Television, and Interactive Games to be played on the television set.

Largely because of the complex circuitry described above, STBs may cost in the range of two hundred dollars for the equipment alone. In addition, it is typically required that the cable or video distribution company send a person to the customer's house to install the STB. Furthermore, additional visits by company technicians may be required when the customer changes the level of service, when upgrades are made to the equipment or software, and when a customer terminates service. Unfortunately for the video distribution companies, the expense of STBs, for both the box itself and the labor to install/maintain, is a very significant cost to the companies and one they have difficulty charging directly to the customer. Because of the competition from entertainment service providers in the cable, satellite, and Internet industries, companies are hesitant to charge for these expenses since they are constantly trying to attract new customers and retain current customers.

In apartment buildings, the problem is exacerbated since the average annual turnover of tenants in apartments nationwide averages between 30-60%. Thus, there are many more customer site visits for installation, service changing, and termination of service. To make matters worse, it is estimated that up to 30% of the times an apartment dweller moves from the premises, the STB leaves with them.

All in all, the cost of supplying and maintaining STBs is undesirably high. It is against this background and with a desire to improve on the prior art that the present invention has been developed.

### SUMMARY OF THE INVENTION

In view of the foregoing, a broad objective of the present invention is to decrease costs associated with installing and maintaining services that until now have required a set-top box at a customer's home. Another objective of the present invention is to decrease the susceptibility of a video distribution system to cable piracy. Another objective is to provide a distribution system that meets the above objectives and also meets regulatory as well as customer requirements while at the same time being economically viable.

In carrying out these and other objectives, features, and advantages of the present invention, a cable distribution system is provided. The system includes a headend receptive of signals from a plurality of video sources, the headend including a plurality of receiver/decoders that are each controllable to receive/decode a selected video channel and provide the video channel at a selected frequency, selected ones of the plurality of video channels being multiplexed together to create one or more multiplexed channel signals. The system also includes a plurality of service modules associated with the headend, each service module receiving one or more of the multiplexed channel signals and providing it to each of a plurality of frequency converters within each service module that each convert one of the video channels to a predetermined frequency, the predetermined output frequency of each frequency converter in a given service module being different from each other, each of the converted video channels created by a given service module being combined together into a single signal. The system further includes a plurality of interface units associated with each service module, each interface unit being located at a customer location, each interface unit receptive of the single signal from the service module, the interface unit passing only one of the video channels in the single signal to a video displaying apparatus.

The headend may be a local headend located in a building or set of buildings where the customer locations are. The system may further include a regional headend located at a location remote from the building or set of buildings, the regional headend providing video channels at selected frequencies to the local headend. The plurality of service modules may be dispersed throughout the building or set of buildings, there being at least one service module for each floor of the building or set of buildings.

The system may further include cabling running between each service module and the plurality of interface modules associated therewith, the cabling being bandwidth limited so as to not efficiently carry signals appreciably above 350 MHz. The cabling may be metallic coaxial cabling. The system may further include cabling running between the headend and each of the plurality of service modules associated therewith, the cabling having sufficient bandwidth capacity to be able to efficiently carry signals as high as 750 MHz.

The local headend may also include a block of Personal Video Recorders. The local headend may also include a Personal Computer. The local headend may also include a DOCSIS frequency converter. A DOCSIS forward channel being carried from an internet service provider to a customer may be converted by the DOCSIS frequency converter to a different frequency for passage to the plurality of service modules and associated interface units. Each of the frequency converters in each of the plurality of service modules may be a programmable converter.

The system may further include a different bandpass filter associated with each frequency converter. Each interface unit may not include a microprocessor. Each interface unit may not include a frequency converter. Each service module may utilize the same predetermined frequencies as each other service module. Each receiver/decoder may receive and decode a given video channel and that channel from that receiver/decoder may be displayed on every video displaying apparatus associated with that local headend.

The interface module may pass information back upstream to its associated service module that includes channel selection information. The information passed back upstream to the service module may also include a DOCSIS return channel that is passed by the service module back to the headend and back to an internet service provider. The system may further include a processor and associated database in communication with the headend and the service module, the processor being functional to control the operation of the receiver/decoders and the database assisting the microprocessor in this functionality and in storing customer viewing preferences. The local service module may only convert a selected video channel to the predetermined output frequency associated with a particular interface unit if that interface unit is authorized to receive that selected video channel.

Another aspect of the present invention relates to a cable distribution system including a headend receptive of signals from a plurality of video sources, the headend including a plurality of receiver/decoders that are each controllable to receive/decode a selected video channel and provide the video channel at a selected frequency, selected ones of the plurality of video channels being multiplexed together to create one or more multiplexed channel signals. The system also includes a plurality of service modules associated with the headend, each service module receiving one or more of the multiplexed channel signals and providing it to each of a plurality of frequency converters within each service module that each convert one of the video channels to a predetermined frequency and create a signal containing that video channel. The system further includes a plurality of interface units associated with each service module, each interface unit being located at a customer location, each interface unit receptive of one of the signals from the service module, the interface unit passing the video channel in the signal to a video displaying apparatus.

Another aspect of the present invention relates to a cable distribution system including a local headend receptive of signals from a plurality of video sources including signals from a regional or cable beadend, the local headend including a plurality of receiver/decoders that are each controllable to receive/decode a selected video channel and provide the video channel at a selected frequency, selected ones of the plurality of video channels being multiplexed together to create one or more multiplexed channel signals. The system also includes a plurality of local service modules associated with the local headend, each local service module receiving one or more of the multiplexed channel signals and providing it to each of a plurality of frequency converters that each convert one of the video channels to a predetermined frequency, the predetermined output frequency of each frequency converter in a given local service module being different from each other, each of the converted video channels created by a given local service module being combined together into a single signal. The system further includes a plurality of interface units associated with each local service module, each interface unit being located at a customer location, each interface unit receptive of the single signal from the local service module, the interface unit passing only one of the video channels in the single signal to a video displaying apparatus. Each of the local service modules utilizes frequencies for its respective frequency converters that are identical to the frequencies utilized by each other local service modules.

Another aspect of the present invention relates to a cable distribution system including a regional headend including at least one of a cable headend and a satellite delivery and transportations system and a local headend located in one of the vicinity of or within a building or set of buildings, the local headend being receptive of signals from a plurality of video sources including signals from the regional headend, the local headend including a plurality of receiver/decoders that are each controllable to receive/decode a selected video channel and provide the video channel at a selected frequency, selected ones of the plurality of video channels being multiplexed together to create one or more multiplexed channel signals. The system also includes a plurality of local service modules located within the building or set of buildings and associated with the local headend, each local service module receiving one or more of the multiplexed channel signals and providing it to each of a plurality of frequency converters that each convert one of the video channels to a predetermined frequency, the predetermined output frequency of each frequency converter in a given local service module being different from each other, each of the converted video channels created by a given local service module being combined together into a single signal. The system further includes a plurality of interface units associated with each local service module, each interface unit being located at a customer location within the building or set of buildings, each interface unit receptive of the single signal from the local service module, the interface unit passing only one of the video channels in the single signal to a video displaying apparatus.

The local service module may only convert a selected video channel to the predetermined output frequency associated with a particular interface unit if that interface unit is authorized to receive that selected video channel.

Numerous additional features and advantages of the present invention will become apparent to those skilled in the art upon consideration of the further description that follows.

### BRIEF DESCRIPTION OF THE DRAWINGS

FIG. 1 is a block diagram of a video distribution system of the present invention.

FIG. 2 is a block diagram of the video distribution system of FIG. 1, showing further detail about a headend thereof.

FIG. 3 is a block diagram of a local service module (LSM) of the video distribution system of FIG. 2.

FIG. 4 is a block diagram of a room interface unit (RIU) of the video distribution system of FIG. 2.

### DETAILED DESCRIPTION OF THE PREFERRED EMBODIMENT

Reference will now be made to the accompanying drawings, which assist in illustrating the various pertinent features of the present invention. Although the present invention will now be described primarily in conjunction with video distribution systems in MDUs such as apartment buildings and hotels, it should be expressly understood that the present invention may be applicable to other applications where it is desired to move more of the circuitry upstream in the video distribution system, thus simplifying the set-top box. In this regard, the following description of a video distribution system is presented for purposes of illustration and description. Furthermore, the description is not intended to limit the invention to the form disclosed herein. Consequently, variations and modifications commensurate with the following teachings, and skill and knowledge of the relevant art, are within the scope of the present invention. The embodiments described herein are further intended to explain best modes known of practicing the invention and to enable others skilled in the art to utilize the invention in such, or other embodiments and with various modifications required by the particular application(s) or use(s) of the present invention.

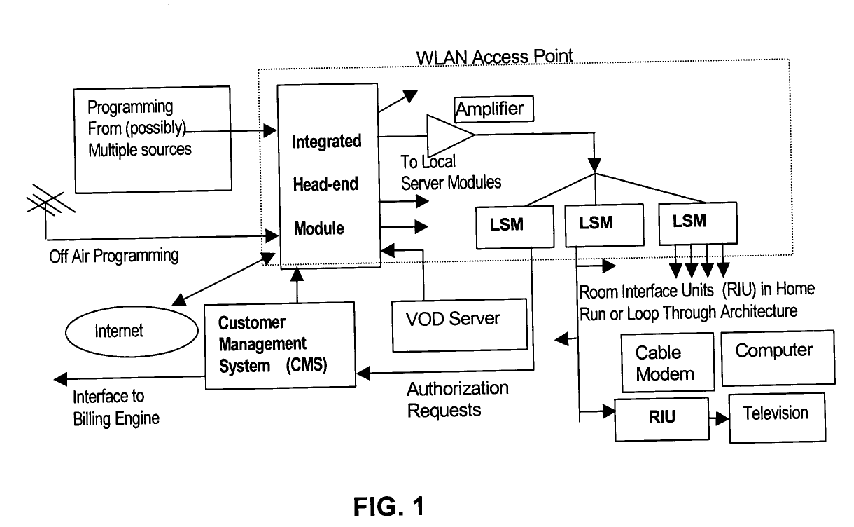

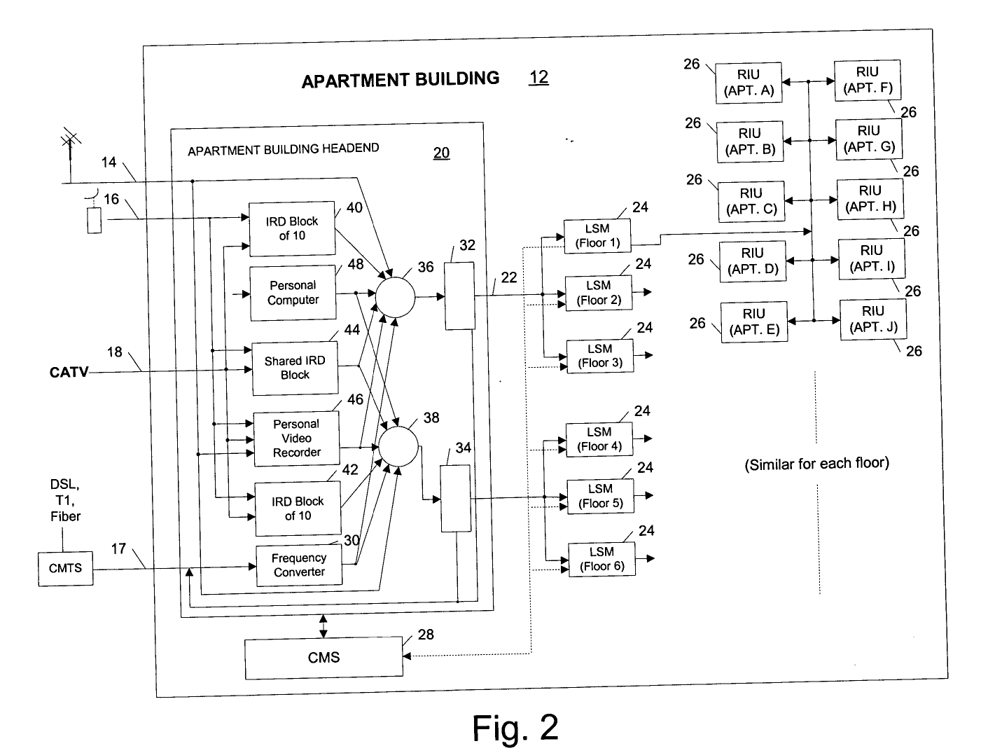

The present invention is first described in conjunction with a video distribution system 10 shown in FIGS. 1 and 2. FIG. 1 shows a generalized block diagram including a basic system description of the video distribution system 10. As will be described in further detail below, the system 10 achieves cost reduction by distributing RF and microprocessor components further upstream. The system includes key elements such as an integrated headend module, a Customer Management System (CMS), Local Server Modules (LSMs), and Room Interface Units (RIUs), each of which will be described in further detail below.

The video distribution system 10 is shown in FIG. 2 implemented in an apartment building 12, although the invention is equally applicable to other scenarios. An antenna may provide a broadcast television antenna signal 14 that is provided to the apartment building 12. In addition, a dish antenna may provide a satellite dish signal 16 to the apartment building 12. Similarly, a cable from a local cable television service provider may provide a cable television signal 18 to the apartment building 12. The signal 18 may come from a regional or cable headend or a satellite delivery and transportation system such as a Digital To Home platform, or other suitable cable delivery system, or a combination thereof. In addition, the cable provider or an alternative provider could provide high-speed Internet connectivity 17 via coaxial cable or other high-speed media that is typically compliant with the Data Over Cable Service Interface Specifications (DOCSIS). Alternatively, internet connectivity could be provided via T1, DSL, Fibre, satellite, or other suitable means. Located within the apartment building 12 is an apartment building headend 20. The headend 20 receives the four signals 14, 16, 17, and 18 while it performs processing that will be described in further detail below, and provides a multiplexed channel signal 22 to a group of local service modules (LSMs) 24. As can be seen in this example, the particular multiplexed channel signal 22 is provided to a group of three local service modules 24, each of which may be located on a different floor of the apartment building 12, although having one LSM per floor is not a requirement. In turn, each local service module 24 performs certain processing that will be described below and provides video channels to a plurality of room interface units (RIUs) 26, one or more of which is located in each of the apartments (each RIU 26 corresponding to a television set in the apartment) on the floor corresponding to that local service module 24. Other details of the processing of the room interface module will also be discussed below. A customer integrated management system (CMS) 28 is also located as part of the integrated headend system in the apartment building 12 and provides certain communication between each of the local service modules 24 and the headend 20.

In this example, the headend 20 at the apartment building 12 includes a first and second IRD block of ten, 40 and 42 respectively. The headend 20 also includes a shared IRD block 44. An IRD, or Integrated Receiver Decoder, in this example could be a simple digital set top box, or a printed circuit card including the functions of RF signal reception, conversion into baseband, decoding of the resultant digital bitstream, selection of the proper program id, and decoding and decryption to convert the signal into its video and audio components. Each IRD block could include a number of such set tops (e.g., 10) or alternatively a set of one or more plug-in printed circuit cards that perform the IRD functions on a number of channels (e.g., 10).

The headend 20 further includes one or more Personal Video Recorders (PVRs) 46 and one or more Personal Computers (PCs) 48. In addition, the headend 20 could include Video On Demand (VOD) servers (not shown). Each of the IRD blocks 40, 42, and 44 and each of the PVRs are receptive of the satellite dish signals 16 and the cable television signal 18. In addition, the PVRs 46 are receptive of the broadcast TV antenna signal 14. The PCs 48 are receptive of an Internet over television signal that could be a part of one of the signals 14, 16, or 18, or could come over a separate line such as a DSL line (not shown). Each of the IRD blocks 40, 42, and 44, the PVRs 46, and the PCs 48 provide an output that is provided to one or both of a first and second signal combiner 36 and 38. Each of the IRD blocks of ten 40 and 42 include ten separate integrated receiver/decoders (IRDs), although the invention is not limited to this particular number. As is well known, each of these IRDs can independently receive and decode a selected video channel from a video source such as the satellite dish signal 16 or the cable television signal 18 and provide a modulated output therefrom at a desired RF frequency. In this case, these IRDs can be externally controlled by the CMS 28 to receive and decode a particular video channel from either the satellite dish signal 16 or the cable television signal 18. The CMS 28 commands each IRD to control which video channel from which of the input signals 16 and 18 will be received and decoded. The PVRs 46 provide PVR service on an “on demand” basis to subscribing customers, as is well known. The PCs 48 receive Internet data and format it for television to allow paying subscribers to use an Internet service over their television. The signal from the PCs 48 is then modulated to a video channel frequency and sent to the signal combiners 36 and 38. These services are created as HTML or XML pages that are properly formatted for television viewing and sent to the appropriate customer television set modulated at the appropriate television frequency.

The headend also includes circuitry for allowing the DOCSIS signals to be routed to and from each apartment. The Internet connectivity signal 17 is provided to one of a group of a frequency converters 30 that converts the forward channel DOCSIS signals from the frequency they are provided on to a predetermined frequency for passage to the signal combiners 36 and 38 and on to the LSMs 24 and RIUs 26. A pair of diplexers 32 and 34, one each associated with one of the signal combiners 36 and 38, respectively, route signals above a certain frequency (e.g., 50 MHz) to the LSMs 24. These signals are multiplexed together as the multiplexed channel signal 22. The diplexers also route signals below that threshold frequency back to the Internet connection 17, as is shown in FIG. 2. In this manner the forward DOCSIS path and the return DOCSIS path is accommodated. As is discussed below the internet connection could be from a cable provider or it could be via a cable modem transmission system (CMTS) as shown in FIG. 2 via DSL, T1, or Fibre cable.

Others of the group of frequency converters 30 could be used to convert or translate frequencies for incoming digital multiplex signals and send them along to the LSM for eventual routing to any subscriber that is authorized to receive digital programming.

In this example, the output of the first IRD block of ten 40 is provided to the first signal combiner 36 and the output of the second IRD block of ten 42 is provided to the second signal combiner 38. The output of the shared IRD block 44 is provided to both the first and second signal combiners 36 and 38. The number of IRDs that may be provided in the shared IRD block 44 can be selected by the system designer based on the particular application for which the video distribution system 10 will be used. For example, the number of IRDs that are needed in a typical apartment building may be different than the number needed for a hotel, which in turn may be different than the number needed in a elderly or assisted-living center. The broadcast television antenna signal 14 is also received by the headend 20 and provided to each of the signal combiners 36 and 38.

In this example, wherein a different group of thirty television sets, corresponding to thirty Room Interface Units (RIUs) in apartments is connected to each of the signal combiners 36 and 38, it is assumed that the thirty televisions/RIUs will have a typical 30% subscription rate to premium channels, such as HBO, Showtime, and Cinemax. Since 30% of thirty subscribers is nine, the dedicated block of ten for each signal combiner should allow each of the premium subscribers to have a dedicated IRD to allow them to watch their selected video channel. In this example, the two IRD blocks of ten 40 and 42 may be used to provide premium channels to those subscribers who are authorized to view the premium channels, while the shared IRD block 44 may provide other “basic” cable channels such as ESPN and CNN that are commonly viewed by multiple subscribers. Experience shows that the use of shared IRD blocks such as these may provide an additional 10-20% capacity. This additional capacity can possibly be used to promote the premium or pay services to non-subscribing customers in order to increase service demand, penetration, and revenues. Of course, if buy rates for the premium services increases in certain buildings or building complexes, then additional IRDs or IRD blocks can be employed.

In this example, each IRD in a given IRD block of ten provides an output at a fixed frequency that is different from the output frequencies of the other IRDs in that block. These frequencies may be selected to be three video channels apart (or some other suitable number such as one or two, for example) depending upon filtering needs for signal purity, where each video channel is typically 6 MHz in bandwidth. Thus, the ten channels from each IRD block of ten may consume 180 MHz and may fall somewhere in the range of 450-750 MHz. Of course, the signals from the shared IRD block 44, as well as the DOCSIS channel are selected to be at frequencies that do not interfere with the output frequencies of either IRD blocks of ten and, in addition, do not interfere with any of the local broadcast video channels received on the broadcast television 14. For example, if the local UHF channel falls in the range of 575 MHz, none of the IRDs in the IRD blocks of ten 40 and 42, or the shared IRD block 44, shall be selected to provide an output at this frequency. Alternatively, the local UHF channel may be frequency translated to some other non-interfering usable frequency.

As is shown in FIG. 2, the multiplexed channel signal 22 is provided from the signal combiner 36 of the headend 20 to a set of three local service modules 24. In addition, a second, and potentially different, multiplexed channel signal 22 is provided from the second signal combiner 38 of the headend 20 to a different set of three local service modules 24. In this example, each local service module 24 may be located on a separate floor of the six-floor apartment building 12. The multiplexed channel signal 22 from the first signal combiner 36 may serve the local service module of the first three floors, while the multiplexed channel signal 22 of the second signal combiner 38 may serve the three local service modules of the top three floors. As is shown in FIG. 2, each local service module 24 on a particular floor provides a signal that is provided to all ten of the room interface units (RIUs) 26 that are located on that floor, one associated with each of the ten televisions on that floor. For ease of illustration, only the RIUs and their corresponding apartments are shown for the first floor. As is typically the case in multi-unit dwellings such as apartments, the lines into each apartment may be in the form of a loop-through or tree-and-branch structure so that separate lines (known as home runs) are not provided from the LSM to each RIU. Nothing about the present invention, however, prevents the LSM from delivering services on a home run basis if that is the architecture in the building.

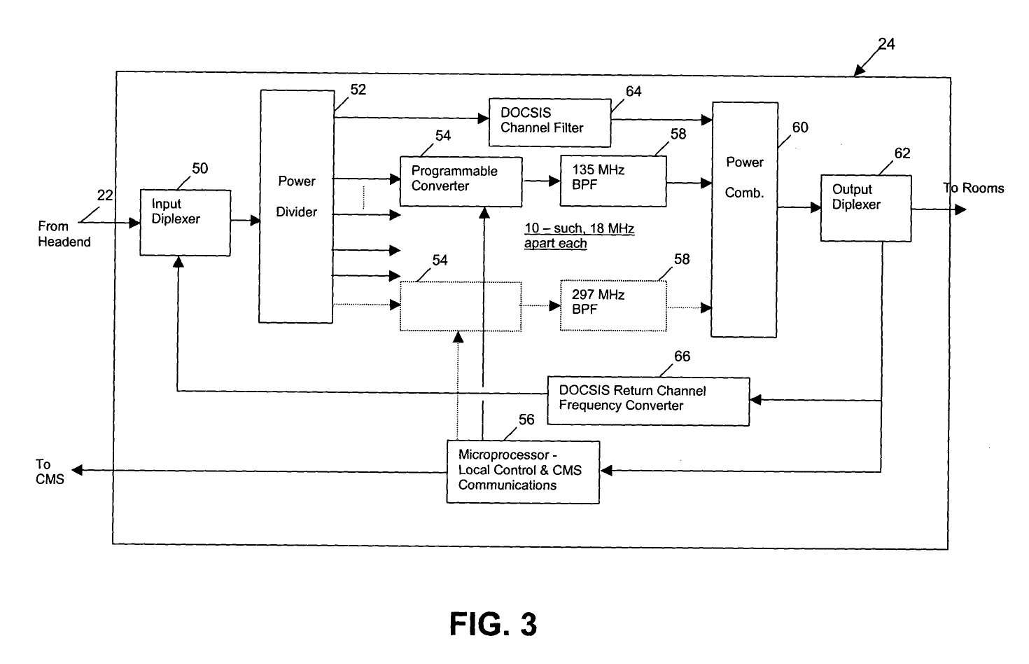

A block diagram of the contents of each of the local service modules 24 is shown in FIG. 3. The local service module 24 includes an input diplexer 50, the function of which will be described in more detail below. The diplexer 50 receives the multiplexed channel signal 22 from the headend 20 and passes the signal to a power divider 52 (which may be a 12-way power divider, a commonly available component). The power divider 52 divides the multiplexed channel signal 22 into a plurality of identical multiplexed channel signals, each of which is provided to a separate programmable converter 54 or to a DOCSIS channel filter 64. Each of the programmable converters 54 is controllable by a microprocessor 56 to convert a video channel selected by the microprocessor from its frequency in the multiplexed channel signal 22 to a predetermined fixed frequency at a frequency location that is assigned to a particular corresponding RIU 26. In this example, the ten programmable converters 54 and the local service module 24 may for example be designed to provide an output frequency located at approximately 18 MHz intervals, the lowest at approximately 135 MHz and the highest at approximately 297 MHz. Just downstream from each of the programmable converters 54 is a bandpass filter (BPF) 58 with a narrow frequency band through which a signal can pass, that frequency band being centered at the output frequency of the programmable converter, which, as stated above, vary in 18 MHz intervals from 135 MHz to 297 MHz, in this example. The outputs from each of these bandpass filters 58 are each provided to a power combiner 60 (which may be a similar component to the power divider 52). The power combiner 60 essentially frequency multiplexes the ten signals from the ten programmable converters 54 (via the bandpass filters 58) to provide a frequency multiplexed signal that is provided to the output diplexer 62. The multiplexed signal is then provided from the output diplexer 62 to the RIU 26 as is shown in FIG. 2.

Alternatively, it is also possible to replace the programmable converters 54 with demodulators/remodulators. This design, however, requires more stringent filtering, although allowing two empty video channels between adjacent channels could help in this regard. In addition, in order to demodulate and remodulate in a fashion that preserves the quality of the audio, such as with stereo sound and video channels, it may be required to utilize more expensive modulation components, which would be undesirable. On the other hand, the frequency conversion approach has the advantage of maintaining the spectral purity of the signal intact so as to allow stereo sound to pass therethrough where possible. In addition, the hardware required to do the frequency conversion may be more readily available and affordable than the demodulator/remodulator approach. Furthermore, with the frequency conversion approach, identical programmable converters can be purchased so that the bulk purchase of a small number of different components can be utilized for this design.

The input diplexer 50 provides the function of separating the upstream DOCSIS return channel from the downstream multiplexed channel signal 22. As described above, the multiplexed channel signal 22 may include a plurality of video channels in the range of 450750 MHz. The DOCSIS return channel may typically be in the range of 10-15 MHz, but a range of 10-45 MHz is reserved. The input diplexer 50 receives the relatively-higher frequency, multiplexed channel signal 22 from the headend 20 and passes it directly through to the power divider 52. The input diplexer 50 also receives the relatively-lower frequency, DOCSIS return signal which it routes back to the headend 20. The DOCSIS channel filter 64 is a bandpass filter in place between the power divider 52 and power combiner 60 to allow only the DOCSIS channel to pass therethrough. This channel filter may be a bandpass filter at the frequency selected for the forward DOCSIS channel which may fall somewhere in the range of 500-800 MHz. A DOCSIS return channel frequency converter 66 receives a DOCSIS return channel signal at a fixed frequency from the output diplexer 62 of the local service module 24 and provides a frequency-selectable return signal back to the cable modem transmission system (CMTS) (at the cable headend) in compliance with DOCSIS specifications. Thus, it is not necessarily a fixed return frequency. By providing a DOCSIS return channel frequency converter 66 at this location, it is possible to have the DOCSIS circuitry in the RIUs 26 operate at a fixed frequency so as to reduce costs while still allowing the DOCSIS return signal to the CMTS to be at a selectable frequency as required by DOCSIS specifications. Alternatively, the frequency conversion for the return path could take place at the headend 20.

The output diplexer 62 operates in a similar fashion to the input diplexer 50, in that it routes signals in different directions depending on the frequency thereof. In this example, for signals of a frequency at or above 50 MHz, those signals are passed to the RIU 26. On the other hand, the frequencies lower than 50 MHz received from the RIU 26 are passed to the DOCSIS return channel frequency converter 66 or the microprocessor 56. This allows for communication between the RIU 26 and the microprocessor 56 of the local service module 24. Just as the DOCSIS return channel operates at a fixed frequency in the RIU 26 and in the portion of the local service module 24 that is upstream (in the return path) of the DOCSIS return channel frequency converter 66, the forward DOCSIS channel that is downstream of the headend is also at a fixed channel frequency to allow for simplified product design. The data path shown in FIG. 2 from the LSMs 24 to the CMS 28 (to allow the microprocessor 56 of each LSM 24 to communicate with the CMS 28) can be via a separate cable (such as an RS-232 cable) from the cable that carries the multiplexed channel signal to the LSMs 24. A separate cable allows the video channel cable to be uni-directional.

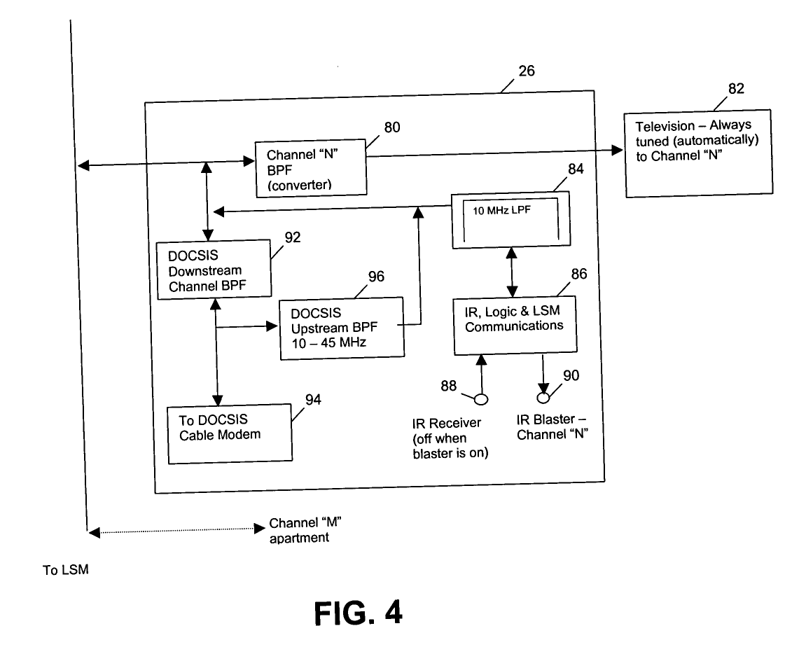

The details of the RIU 26 can be appreciated in FIG. 4. The RIU 26 includes a channel N bandpass filter 80 that allows the video channel frequency (the frequency associated with channel N) associated with this particular RIU 26 to pass therethrough. Recall that the frequency multiplexed signal coming to the RIU 26 from the local service module 24 includes ten separate video channels, in this example. Only one of those video channels is intended for this RIU and it is placed at a predetermined frequency by a corresponding programmable converter 54 in the local service module 24. Therefore, in this particular RIU 26, this channel N bandpass filter 80 allows only one of those video channels on the multiplexed video channel signal to pass therethrough to a television 82 which is automatically tuned to channel N, as will be described in further detail below. Thus, if we assume that this particular RIU 26 being illustrated in this example is assigned a video channel frequency at approximately 171 MHz (thus, channel N is channel 22), then the bandpass filter 80 will be selected to pass only frequencies in that range and the television will be tuned to that channel which is commonly known to be channel 22 from the standard U.S. CATV channel frequency allocation. Of course, this does not necessarily mean that the programming the customer sees on his television 82 corresponds to the program material that the local CATV provider typically provides on cable television channel 22. Instead, it means that this customer will always receive his selected channel on channel 22. As will be described in further detail below, he can choose/select any channel he is authorized to receive and the programmable converter 54 in his corresponding local service module 24 will be automatically programmed to tune to that selected channel and his selected video channel will be provided on the frequency which his television understands to be CATV channel 22. Thus, it can be appreciated that each television and RIU 26 has a corresponding programmable converter 54 in its corresponding local service module 24. More specifically, there is a one-to-one relationship between each programmable converter 54 and a specific RIU 26 (apartment).

Alternatively, each RIU could have a programmable frequency converter that is tuned in each RIU to a particular channel frequency in such a way that the desired output is always at a fixed channel, for example channel 3 or 4 (as is usual in VHS tape recorders) at every television set.

Continuing with the description of the RIU 26, a low pass filter 84, and an IR, Logic, and LSM communications unit 86 work together to allow the customer to select channels and to automatically tune the television 82 to channel N. The communication unit 86 receives a signal from an infrared (IR) receiver 88 when the customer operates his television remote to select a different channel. The communications unit 86 has sufficient processing therein to be able to receive communications from a variety of different types of manufacturers' television remote controls. The communications unit 86 recognizes that a different channel has been requested by the customer and a signal (less than 3 MHz) is sent upstream through the low pass filter 84 (which may pass frequencies below 10 MHz in this example). This signal is sent back to the local service module 24 where the output diplexer 62 routes the signal to the microprocessor 56, as shown in FIG. 3. The communications unit 86 may be designed to append a predetermined code to each request to the LSM 24 that signifies which apartment the request comes from. The communication unit 86 can also be designed to answer simple queries from the LSM 24 so that any tampering with the RIU 26 can be detected.

The microprocessor 56 (of the LSM 24) determines if the channel selected is a local broadcast channel. If so, then the microprocessor 56 commands the programmable converter 54 that corresponds to this particular RIU 26 to convert that broadcast channel to the fixed frequency (channel N) already predetermined for communication from the local service module 24 to the RIU 26 and television 82, as previously described. If the channel selected is not a local broadcast channel, then the microprocessor 56 sends a signal to the CMS 28 (FIG. 2) which in turn commands an RID in either the corresponding IRD block of ten or the shared IRD block 44 to receive and decode the selected video channel. As is well known, the IRD can place textual information in the video portion of the video channel (for a desired number of seconds) to inform the customer of the channel selected and certain other program information as may be desired or may be required by regulatory agencies. The CMS 28 informs the microprocessor 56 in the local service module 24 of the frequency where the selected IRD has placed that selected video channel. The microprocessor 56 of the local service module can then command its corresponding programmable converter 54 to tune to that selected frequency and thus provide the selected video channel to the corresponding RIU 26. If the customer is not a paid subscriber as to the selected video channel, then a message is created by the CMS informing the customer that a subscription fee is needed and offering alternative methods and durations of such a subscription. This message may be created by HTML or XML or other suitable format and sent to the television as a web page.

At the same time this channel selection is taking place in the RIU 26, the local service module 24, and the headend 20, the communication unit 86 of the RIU needs to make sure the television 82 does not change channels to the channel selected by the customer. This is accomplished with the IR blaster 90, which transmits a channel request to the television 82 to remain tuned to channel N. Of course, as is well known, IR blasters have sufficient power to allow the infrared signal to reflect from any surface in the room until it reaches the television 82. Furthermore, the communications unit 86 has sufficient processing to allow it to generate a channel request signal via its IR blaster 90 in the format expected by the television 82. Should the IR blaster 90 be blocked in some fashion by the customer so that the channel request signal cannot be transmitted to the television 82, the customer will have problems changing to the desired channel and may be restricted to viewing only one of the channels the other apartments on his/her floor is watching, at most, and then only by removing the RIU, which act can immediately be detected by the microprocessor 56 of the LSM 24, which is in communication with the RIU 26.

The RIU 26 also handles DOCSIS signals received from the local service module 24. A DOCSIS downstream channel bandpass filter 92 allows the forward DOCSIS channel to pass therethrough at its predetermined frequency, which was previously stated to be in the range of 500-800 MHz. This forward channel is passed to a DOCSIS cable modem 94 which may be in communication with a computer, as is well known. The DOCSIS cable modem 94 passes a return channel DOCSIS signal to a DOCSIS upstream bandpass filter 96, which may allow signals in the range of 10-45 MHz to pass therethrough. This signal is provided back to the output diplexer 62 of the local service module 24.

If a customer requests a program guide, an IRD channel is assigned to that customer to display the program guide. If a customer requests to operate in an interactive mode on an “interactive enabled” program, the LSM 24 passes the request back to the CMS 28. If the customer is currently on a dedicated IRD, the CMS 28 passes the request to that IRD, which sends the appropriate information to the customer. If that IRD is not “interactive enabled” then a message such as “This feature is not available on this channel” is superimposed on the video. If the customer is on a shared IRD when the request to operate in interactive mode is received, the customer is switched to a dedicated IRD, which dedicated IRD is also sent the interactive request after the appropriate delay for the channel acquisition by the IRD.

The customer's use of a PVR 46 (or VOD server) requires authorization or system OK to such a service. If the customer does subscribe to the service, then upon request a PVR or VOD resource at the headend 20 will be dedicated to the customer. The PVR 46 tracks the customer's tastes and records programs automatically or on command. When the customer is viewing material recorded by the PVR 46, the signal therefrom is modulated to a video channel frequency and sent to the appropriate signal combiner.

The IRDs can also be equipped with interactive game capability, which can be offered on a subscription basis to customers. Such a service would also use a dedicated IRD, similar to the interactive mode operation described above. Such a service can be heavily promoted and can allow for a variety of types and lengths of subscriptions. Since the television service is web enabled, properly formatted web games can also be played on the system. For example, card games might be very attractive in elderly or retirement communities.

As can be appreciated, with each of the ten RIUs 26 in the ten respective apartments on the given floor corresponding to that local service module 24 operating in a similar fashion, the local service module 24 provides a frequency multiplexed signal that contains ten different video channels thereon. Since each of the RIUs 26 on that floor are designed to pass only the video channel that is located at a predetermined frequency, the television 82 attached to that corresponding RIU 26 will receive only the video channel selected by the local service module 24. As can be appreciated, if a customer in a given apartment decides to bypass the RIU 26 and hooks the television 82 directly to the signal coming from the local service module 24, then that customer can only receive one of the ten video channels provided by the corresponding local service module 24. In addition, that customer will have not have the ability to enter a request to select a different channel, so the customer will be restricted to watching one of the channels selected by the other apartments on that floor. In other words, the customer would have no control over what channel he is watching. Furthermore, attaching a television 82 directly to the signal from the local service module 24 may allow the local service module 24 to detect the leakage of the local oscillator signal from the television 82 so that the local service module 24 can determine that someone has bypassed their RIU 26. Such tampering could be reported further upstream so that actions could be taken.

An alternative design would provide for a frequency converter in the RIU 26 rather than the channel N bandpass filter 80. In this case, the frequency converter in the RIU 26 would convert channel N to a standard channel such as channel 3 or 4 to which the television 82 could be tuned, such as is common with a VCR. This design would allow for another technique for foiling customers' attempts to bypass the RIU 26. This could be done by having the programmable converter 54 in the local service modules 24 perform a spectral inversion so that the 6 MHz video channel could be flipped to place the audio portion at a relatively lower frequency than the video portion. Of course, conventional video channels have the video portion at a relatively lower frequency than the audio portion. The frequency converter in the RIU 26 would also be spectrally inverting so that it would return the frequency composition of the video channel to the typical arrangement for receipt by the television 82. In this case, if the customer were to attempt to bypass the RIU 26, the television 82 would receive a spectrally inverted signal and nothing usable could be viewed or listened to through the television 82. In this case, it may be desirable to provide the customer with a separate remote for commanding channel changes through the RIU 26, and the IR blaster function could be eliminated from the RIU 26.

It is a commonly accepted specification in the broadcast and cable industry that the signal provided to a television should have greater than a 40 dB signal-to-noise ratio. The typical output specification of an IRD is greater than 60 dB signal-to-noise ratio. Although as many as three frequency conversions (each having a noise figure of 8.7 dB) take place between the IRD and the television, with appropriate low noise gain blocks, the noise figure of the entire path to the customer's television 82 can be made to be less than 10 dB. This provides a 10 dB margin at the customer television by providing a signal-to-noise ratio of at least 50 dB. In actuality, the margin could be made much higher.

Although this simple example provides for a six-story apartment building, with each floor of the building having ten apartments, it can be appreciated that this invention is scalable up or down across a broad range. In addition, this invention can be equally applied to many other types of MDUs, such as garden apartment complexes, hotels, assisted living centers, cluster housing, or even some single family home areas, and the like. Furthermore, the number of IRDs in an IRD block is not required to be ten. In addition, the number of shared IRD blocks, or the number of IRDs in each shared IRD block is variable. It is not necessary for the present invention to be applied only to single building, multi-unit dwellings, it could also be applicable to any other kind of densely populated area. In addition, some part of the CMS might be maintained or shared between a number of structures or complexes in close proximity if it increases functionality or reduces cost. In cases where the premium subscriber penetration increases within the area addressed by a group of LSM blocks, additional IRD cards or an additional IRD block may be inserted. Furthermore, it may be possible to reduce the minimum frequency separation between IRD channels to be 12 MHz rather than 18 MHz.

As can be appreciated, the video distribution system 10 of the present invention provides many advantages. The invention provides a system in which a simplified device (as compared to a conventional set-top box) is provided at the customer's home. For example, it is not necessary for the RIU to include a microprocessor, a typical component in an STB. This not only reduces the cost of the device provided in the home, but may reduce both the number of service calls needed as well as the losses resulting from stolen or damaged RIUs. Furthermore, it may be desirable to mount the RIU internally in a wall rather than on top of a television, as is typical with a set-top box. As can be appreciated, more of the processing has been placed in upstream components such as the local service module and a headend. Since there are a greatly reduced number of these upstream components as compared to downstream components, increased cost savings are realized. In addition, these upstream components are designed to be standardized so that a large quantity of a small number of different components can be purchased rather than a smaller quantity of a large number of different components as is the case with many other prior art designs. Furthermore, a system has been provided in which cable piracy is not practical for the customer, either because no signal can be obtained, because the signal may be unusable, because the piracy may be easily detectible by the local service module, or because the customer may have no selection over the video channel received as a result of the piracy. Although only ten programmable converters are provided per local service module and only three local service modules are provided per signal combiner, these numbers are not fixed and only selected in this example to satisfy typical bandwidth constraints.

It can be appreciated that when a customer selects a channel that requires an IRD, that the IRD displays program information in a textual fashion for a given period of time (e.g., five seconds) and then the IRD no longer displays the program information. At this point, the customer can be switched over to a shared IRD if there is one already receiving/decoding this channel, freeing up the IRD in the IRD block of ten for other customers. The switch may be perceptible, but it will only be momentary. Various algorithms for switching between the dedicated and the shared IRD resources could be used, and they could depend on the type of MDU in which the system is implemented.

It can also be appreciated that another advantage of this system is that all communications downstream from the LSM 24 to the RIUs 26 are at approximately 300 MHz or below so that relatively less expensive cabling can be used. By way of contrast, the communications from video sources 14, 16, and 18 to the headend 20 and from the headend to the LSMs 24 may need cabling that allows for communication at up to 750 MHz.

Another important advantage of the system is that with the LSM 24 and CMS 28 having appropriate intelligence, the CMS 28 can determine the usage of channels in the building on a time basis and reassign shared IRD assets. For example, if every day at 7 am in a particular building a majority of the people are watching CNN, HBO, Games, Discovery, ESPN, Weather, CNBC, CBS News, PBS, and ABC News, and at some other time (e.g., 9 pm) a majority are watching some other set of channels, the shared group of IRD's can be so assigned, thus allowing for the minimal number of IRDs needed in any MDU or hotel.

Another advantage is that the CMS 28 in its database can keep track of every selection a subscriber makes. This data can be made available or marketed as extremely valuable customer preference marketing information.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

What is claimed is:

1. A cable distribution system, comprising:
a headend receptive of signals from a plurality of video sources, the headend including a plurality of receiver/decoders that are each controllable to receive/decode a selected video channel and provide the video channel at a selected frequency, selected ones of the plurality of video channels being multiplexed together to create one or more multiplexed channel signals;
a plurality of service modules associated with the headend, each service module receiving one or more of the multiplexed channel signals and providing it to each of a plurality of frequency converters within each service module that each convert one of the video channels to a predetermined frequency, the predetermined output frequency of each frequency converter in a given service module being different from each other, each of the converted video channels created by a given service module being combined together into a single signal; and
a plurality of interface units associated with each service module, each interface unit being located at a customer location, each interface unit receptive of the single signal from the service module, the interface unit passing only one of the video channels in the single signal to a video displaying apparatus.

2. A cable distribution system as defined in claim 1, wherein the headend is a local headend located in a building or set of buildings where the customer locations are.

3. A cable distribution system as defined in claim 2, further including a regional headend located at a location remote from the building or set of buildings, the regional headend providing video channels at selected frequencies to the local headend.

4. A cable distribution system as defined in claim 2, wherein the plurality of service modules are dispersed throughout the building or set of buildings, there being at least one service module for each floor of the building or set of buildings.

5. A cable distribution system as defined in claims 1, further including cabling running between each service module and the plurality of interface modules associated therewith, the cabling being bandwidth limited so as to not efficiently carry signals appreciably above 350 MHz.

6. A cable distribution system as defined in claim 5, wherein the cabling is metallic coaxial cabling.

7. A cable distribution system as defined in claim 1, further including cabling running between the headend and each of the plurality of service modules associated therewith, the cabling having sufficient bandwidth capacity to be able to efficiently carry signals at least as high as 750 MHz.

8. A cable distribution system as defined in claim 2, wherein the local headend also includes a block of Personal Video Recorders.

9. A cable distribution system as defined in claim 2, wherein the local headend also includes a Video On Demand Server.

10. A cable distribution system as defined in claim 2, wherein the local headend also includes a Personal Computer.

11. A cable distribution system as defined in claim 2, wherein the local headend also includes a DOCSIS frequency converter.

12. A cable distribution system as defined in claim 11, wherein a DOCSIS forward channel being carried from an internet service provider to a customer is converted by the DOCSIS frequency converter to a different frequency for passage to the plurality of service modules and associated interface units.

13. A cable distribution system as defined in claim 1, wherein each of the frequency converters in each of the plurality of service modules is a programmable converter.

14. A cable distribution system as defined in claim 1, further including a different bandpass filter associated with each frequency converter.

15. A cable distribution system as defined in claim 1, wherein each interface unit does not include a microprocessor.

16. A cable distribution system as defined in claim 1, wherein each interface unit does not include a frequency converter.

17. A cable distribution system as defined in claim 1, wherein each service module utilizes the same predetermined frequencies as each other service module.

18. A cable distribution system as defined in claim 1, wherein each receiver/decoder receives and decodes a given video channel and that channel from that receiver/decoder can be displayed on every video displaying apparatus associated with that local headend.

19. A cable distribution system as defined in claim 1, wherein the interface module passes information back upstream to its associated service module that includes channel selection information.

20. A cable distribution system as defined in claim 19, wherein the information passed back upstream to the service module also includes a DOCSIS return channel that is passed by the service module back to the headend and back to an internet service provider.

21. A cable distribution system as defined in claim 1, further including a processor and associated database in communication with the headend and the service module, the processor being functional to control the operation of the receiver/decoders and the database assisting the microprocessor in this functionality and in storing customer viewing preferences.

22. A cable distribution system as defined in claim 1, wherein the local service module will only convert a selected video channel to the predetermined output frequency associated with a particular interface unit if that interface unit is authorized to receive that selected video channel.

23. A cable distribution system as defined in claim 2, wherein the local headend includes a cable mode transmission system (CMTS).

24. A cable distribution system, comprising:
a headend receptive of signals from a plurality of video sources, the headend including plurality of receiver/decoders that are each controllable to receive/decode a selected video channel and provide the video channel at a selected frequency, selected ones of the plurality of video channels being multiplexed together to create one or more multiplexed channel signals;
a plurality of service modules associated with the headend, each service module receiving one or more of the multiplexed channel signals and providing it to each of a plurality of frequency converters within each service module that each convert one of the video channels to a predetermined frequency and create a signal containing that video channel; and
a plurality of interface units associated with each service module, each interface unit being located at a customer location, each interface unit receptive of one of the signals from the service module, the interface unit passing the video channel in the signal to a video displaying apparatus.

25. A cable distribution system as defined in claim 24, wherein cabling between the service modules and the-interface units is in a home run architecture.

26. A cable distribution system as defined in claim 24, wherein cabling between the service modules and the interface units is in a loop through architecture.

27. A cable distribution system, comprising:
a local headend receptive of signals from a plurality of video sources including signals from a regional or cable headend, the local headend including a plurality of receiver/decoders hat are each controllable to receive/decode a selected video channel and provide the video channel at a selected frequency, selected ones of the plurality of video channels being multiplexed together to create one or more multiplexed channel signals;
a plurality of local service modules associated with the local headend, each local service module receiving one or more of the multiplexed channel signals and providing it to each of a plurality of frequency converters that each convert one of the video channels to a predetermined frequency, the predetermined output frequency of each frequency converter in a given local service module being different from each other, each of the converted video channels created by a given local service module being combined together into a single signal; and
a plurality of interface units associated with each local service module, each interface unit being located at a customer location, each interface unit receptive of the single signal from the local service module, the interface unit passing only one of the video channels in the single signal to a video displaying apparatus;
wherein each of the local service modules utilizes frequencies for its respective frequency converters that are identical to the frequencies utilized by each other local service modules.

28. A cable distribution system, comprising:
a regional headend including at least one of a cable headend and a satellite delivery and transportations system;
a local headend located in one of the vicinity of or within a building or set of buildings, the local headend being receptive of signals from a plurality of video sources including signals from the regional headend, the local headend including a plurality of receiver/decoders that are each controllable to receive/decode a selected video channel and provide the video channel at a selected frequency, selected ones of the plurality of video channels being multiplexed together to create one or more multiplexed channel signals;
a plurality of local service modules located within the building or set of buildings and associated with the local headend, each local service module receiving one or more of the multiplexed channel signals and providing it to each of a plurality of frequency converters that each convert one of the video channels to a predetermined frequency, the predetermined output frequency of each frequency converter in a given local service module being different from each other, each of the converted video channels created by a given local service module being combined together into a single signal; and
a plurality of interface units associated with each local service module, each interface unit being located at a customer location within the building or set of buildings, each interface unit receptive of the single signal from the local service module, the interface unit passing only one of the video channels in the single signal to a video displaying apparatus.

29. A cable distribution system as defined in claim 28, wherein the local service module will only convert a selected video channel to the predetermined output frequency associated with a particular interface unit if that interface unit is authorized to receive that selected video channel.
